(19) United States
(12) Patent Application Publication
(10) Pub. No.: US 2025/0184775 A1
(43) Pub. Date: Jun. 5, 2025

(54) METHOD AND APPARATUS FOR CHANNEL STATE INFORMATION (CSI) PREDICTION

(71) Applicant: MEDIATEK INC., Hsinchu City (TW)

(72) Inventor: Gyu Bum KYUNG, San Jose, CA (US)

(21) Appl. No.: 18/840,676

(22) PCT Filed: Mar. 13, 2023
(86) PCT No.: PCT/CN2023/081013

§ 371 Date: Aug. 22, 2024

Related U.S. Application Data
(60) Provisional application No. 63/328,764, filed on Apr. 8, 2022.

(51) Int. Cl. H04W 24/06

(52) U.S. Cl. CPC H04W 24/06

(57) ABSTRACT

This disclosure provides an apparatus and a method for channel state information (CSI) prediction. Processing circuitry of the apparatus obtains a plurality of CSI measurements. Each CSI measurement is measured at a different time instant. The processing circuitry generates a context vector from an encoder of a transformer based neural network, based on the plurality of CSI measurements being input to the encoder of the transformer based neural network. The processing circuitry generates one or more predicted CSI values from a decoder of the transformer based neural network, based on the context vector being input to the decoder of the transformer based neural network.

### INCORPORATION BY REFERENCE

This present disclosure claims the benefit of U.S. Provisional Application No. 63/328,764, filed on Apr. 8, 2022, which is incorporated herein by reference in its entirety.

### TECHNICAL FIELD

The present disclosure relates to wireless communications, and specifically to a procedure for channel state information prediction between a transmitter and a receiver.

### BACKGROUND

In wireless communications, channel state information (CSI) can estimate channel properties of a communication link between a transmitter and a receiver. In related arts, the receiver can estimate the CSI of the communication link and feedback the raw CSI to a transmitter. This procedure can consume a great deal of communication resources and place a tremendous strain on a wireless network using modern multiple-input and multiple-output (MIMO) technology.

### SUMMARY

Aspects of the disclosure provide a method for channel state information (CSI) prediction. Under the method, a plurality of CSI measurements is obtained. Each CSI measurement is measured at a different time instant. A context vector is generated from an encoder of a transformer based neural network, based on the plurality of CSI measurements being input to the encoder of the transformer based neural network. One or more predicted CSI values are generated from a decoder of the transformer based neural network, based on the context vector being input to the decoder of the transformer based neural network.

In an embodiment, the encoder includes one or more encoding layers each including a multi-head attention sub-layer and a feed-forward sub-layer.

In an embodiment, for each of the one or more encoding layers, a first residual connection is around the multi-head attention sub-layer followed by a first layer normalization, and a second residual connection is around the feed-forward sub-layer followed by a second layer normalization.

In an embodiment, the decoder includes one or more decoding layers each including a masked multi-head attention sub-layer, a multi-head attention sub-layer, and a feed-forward sub-layer.

In an embodiment, for each of the one or more decoding layers, a first residual connection is around the masked multi-head attention sub-layer followed by a first layer normalization, a second residual connection is around the multi-head attention sub-layer followed by a second layer normalization, and a third residual connection is around the feed-forward sub-layer followed by a third layer normalization.

In an embodiment, each CSI measurement is one of a channel matrix, a precoder matrix of the channel matrix, a covariance matrix of the channel matrix, and a transformed matrix of the channel matrix.

In an embodiment, the channel matrix is in a three dimensional domain that is represented by a transmit antenna index, a time domain index, and a frequency domain index.

In an embodiment, the transformed matrix is in a three dimensional domain that is represented by a transmit beam index, a delay component index, and a Doppler component index.

In an embodiment, the channel matrix is in a four dimensional domain that is represented by a receive antenna index, a transmit antenna index, a time domain index, and a frequency domain index.

In an embodiment, the transformed channel matrix is in a four dimensional domain that is represented by a receive beam index, a transmit beam index, a delay component index, and a Doppler component index.

Aspects of the disclosure provide an apparatus for CSI prediction. Processing circuitry of the apparatus obtains a plurality of CSI measurements. Each CSI measurement is measured at a different time instant. The processing circuitry generates a context vector from an encoder of a transformer based neural network, based on the plurality of CSI measurements being input to the encoder of the transformer based neural network. The processing circuitry generates one or more predicted CSI values from a decoder of the transformer based neural network, based on the context vector being input to the decoder of the transformer based neural network.

In an embodiment, the encoder includes one or more encoding layers each including a multi-head attention sub-layer and a feed-forward sub-layer.

In an embodiment, for each of the one or more encoding layers, a first residual connection is around the multi-head attention sub-layer followed by a first layer normalization, and a second residual connection is around the feed-forward sub-layer followed by a second layer normalization.

In an embodiment, the decoder includes one or more decoding layers each including a masked multi-head attention sub-layer, a multi-head attention sub-layer, and a feed-forward sub-layer.

In an embodiment, for each of the one or more decoding layers, a first residual connection is around the masked multi-head attention sub-layer followed by a first layer normalization, a second residual connection is around the multi-head attention sub-layer followed by a second layer normalization, and a third residual connection is around the feed-forward sub-layer followed by a third layer normalization.

In an embodiment, each CSI measurement is one of a channel matrix, a precoder matrix of the channel matrix, a covariance matrix of the channel matrix, and a transformed matrix of the channel matrix.

In an embodiment, the channel matrix is in a three dimensional domain that is represented by a transmit antenna index, a time domain index, and a frequency domain index.

In an embodiment, the transformed matrix is in a three dimensional domain that is represented by a transmit beam index, a delay component index, and a Doppler component index.

In an embodiment, the channel matrix is in a four dimensional domain that is represented by a receive antenna index, a transmit antenna index, a time domain index, and a frequency domain index.

In an embodiment, the transformed channel matrix is in a four dimensional domain that is represented by a receive beam index, a transmit beam index, a delay component index, and a Doppler component index.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary procedure of CSI feedback according to embodiments of the disclosure;

FIG. 2 shows another exemplary procedure of CSI feedback according to embodiments of the disclosure;

FIG. 3 shows an exemplary transformer based CSI prediction architecture according to embodiments of the disclosure;

FIG. 4A shows an example of an encoder of the transformer based CSI prediction architecture according to embodiments of the disclosure;

FIG. 4B shows an example of a decoder of the transformer based CSI prediction architecture according to embodiments of the disclosure;

FIG. 5 shows an exemplary apparatus according to embodiments of the disclosure; and

FIG. 6 shows a flowchart outlining a process according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In wireless communications, channel state information (CSI) can estimate channel properties of a communication link between a transmitter and a receiver. For example, CSI can describe how a signal propagates from the transmitter to the receiver, and represent a combined effect of phenomena such as scattering, fading, power loss with distance, and the like. Thus, CSI can also be referred to as channel estimation. CSI can make it feasible to adapt the transmission between the transmitter and the receiver to current channel conditions, and thus is a critical piece of information that needs to be shared between the transmitter and the receiver to allow high-quality signal reception.

In an example, the transmitter and the receiver (or transceivers) can rely on CSI to compute their transmit precoding and receive combining matrices, among other important parameters. Without CSI, a wireless link may suffer from a low signal quality and/or a high interference from other wireless links.

To estimate CSI, the transmitter can send a predefined signal to the receiver. That is, the predefined signal is known to both the transmitter and the receiver. The receiver can then apply various algorithms to perform CSI estimation. At this stage, CSI is known to the receiver only. The transmitter can rely on feedback from the receiver for acquiring CSI knowledge.

Raw CSI feedback, however, may require a large overhead which may degrade the overall system performance and cause a large delay. Thus, the raw CSI feedback is typically avoided.

Alternatively, from CSI, the receiver can extract some important or necessary information for the transmitter operations, such as precoding weights, rank indicator (RI), channel quality indicator (CQI), modulational and coding scheme (MCS), and the like. The extracted information can be much smaller than the raw CSI, and the receiver can only feedback these small pieces of information to the transmitter.

To further reduce the overhead, the receiver can estimate the CSI of the communication link and select a best transmit precoder from a predefined codebook of precoders based on the estimated CSI. Further, the receiver can feed information related to the selected best transmit precoder back to the transmitter, such as PMI from such a codebook. This procedure can consume a great deal of communication resources and place a tremendous strain on a wireless network using modern multiple-input and multiple-output (MIMO) technology.

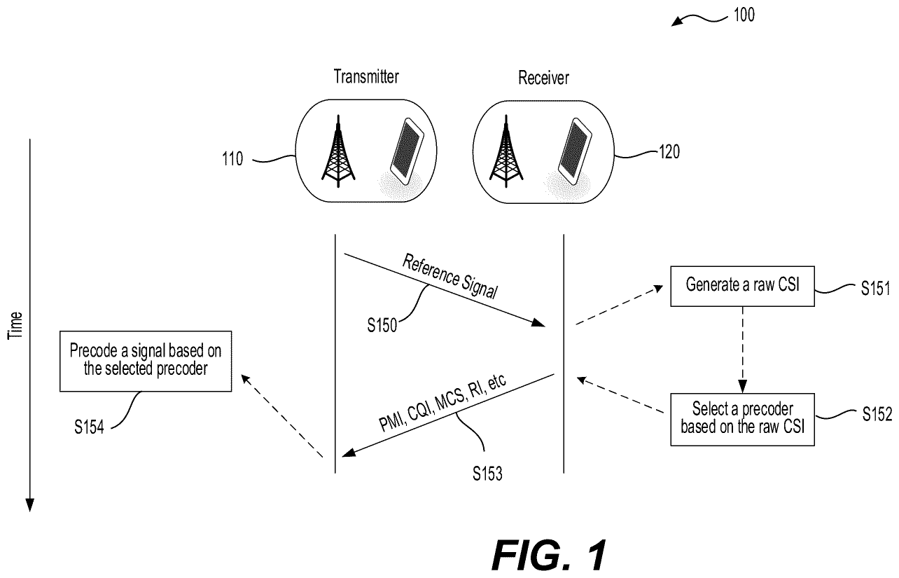

FIG. 1 shows an exemplary procedure 100 of CSI feedback according to embodiments of the disclosure. In the procedure 100, each of a transmitter 110 and a receiver 120 can be a user equipment (UE) or a base station (BS).

At step S150, the transmitter 110 can transmit a reference signal (RS) to the receiver 120. The RS is also known to the receiver 120 before the receiver 120 receives the RS. In an embodiment, the RS can be specifically intended to be used by devices to acquire CSI and thus is referred to as CSI-RS.

At step S151, after receiving the CSI-RS, the receiver 120 can generate a raw CSI by comparing the received CSI-RS with the transmitted CSI-RS that is already known to the receiver 120.

At step S152, the receiver 120 can select a best transmit precoder from a predefined codebook of precoders based on the raw CSI.

At step S153, the receiver 120 can send a PMI of the selected precoder back to the transmitter 110, along with relevant information such as CQI, RI, MCS, and the like.

At step S154, after receiving the PMI and the relevant information, the transmitter 110 can determine transmission parameters and precode a signal based on the selected precoder indicated by the PMI.

It is noted that a choice of the precoders is restricted to the predefined codebook in the procedure 100. However, restricting the choice of the precoders to the predefined codebook can limit the achievable system performance. Different precoder codebooks (e.g., 3GPP NR downlink Type I-Single Panel/Multi-Panel, Type II, eType II, or uplink codebook) have different preset feedback overheads. If the network specifies a preset codebook before the raw CSI is estimated at the receiver, the receiver is not able to further optimize the codebook selection based on tradeoffs between the feedback overhead and the system performance.

Aspects of this disclosure provide methods and embodiments to feedback a compressed version of raw CSI to a transmitter. Based on the compressed CSI, the transmitter is able to optimally compute a precoder for precoding a transmitting signal, and also optimally decide on other transmission parameters such as RI, MCS, and the like. Further, a compression ratio used in compressing the raw CSI can be decided dynamically after the raw CSI has been estimated, in order to allow an optimal tradeoff between the feedback overhead and the system performance.

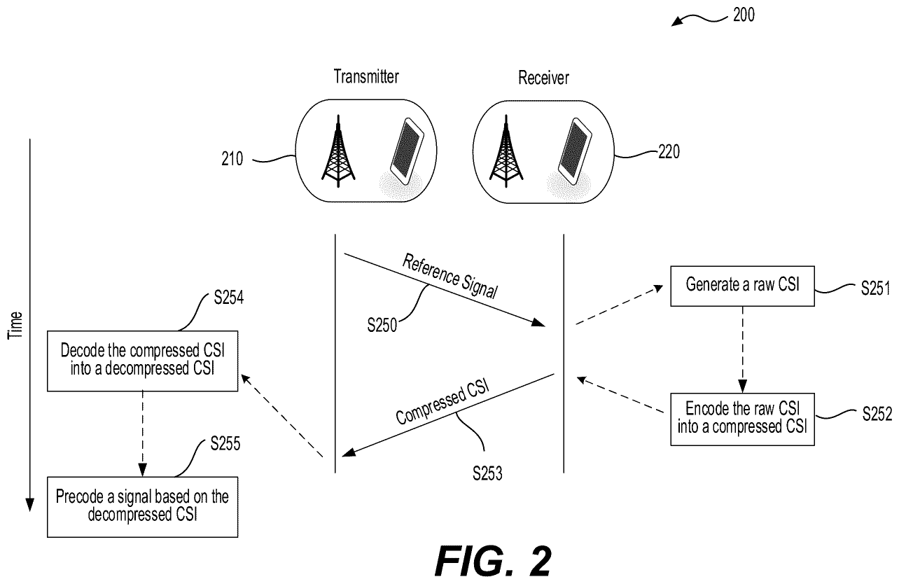

FIG. 2 shows an exemplary procedure 200 of CSI feedback according to embodiments of the disclosure. In the procedure 200, each of a transmitter 210 and a receiver 220 can be a user equipment (UE) or a base station (BS), and steps S250 and S251 are similar to steps S150 and S151 in the procedure 100 of FIG. 1, respectively.

At step S252, the receiver 220 can encode (or compress) the raw CSI into a compressed CSI.

At step S253, the receiver 220 can send the compressed CSI back to the transmitter 210.

At step S254, the transmitter 210 can decode (or decompress) the compressed CSI into a decompressed CSI.

At step S255, the transmitter 210 can determine transmission parameters and precode a signal based on the decompressed CSI.

According to aspects of the disclosure, a massive MIMO system can be used to increase downlink (DL) and/or uplink (UL) throughput between a transmitter and a receiver. However, downlink CSI feedback overhead can be significantly increased due to a large number of antennas at a BS. Accordingly, CSI compression can help to reduce the CSI feedback overhead.

An n_{R}×n_{T} MIMO channel in an orthogonal frequency-division multiplexing (OFDM) system can be expressed as a four dimensional (4D) channel matrix

$$H [ n , m ] = [ \begin{matrix}{h}_{11} [ n , m ] & … & {h}_{1 {n}_{T}} [ n , m ] \\ ⋮ & ⋱ & ⋮ \\ {h}_{{n}_{R} 1} [ n , m ] & … & {h}_{{n}_{R} {n}_{T}} [ n , m ]\end{matrix} ] ,$$

where n_{R} is a number of receive antennas (e.g., at UE) and n_{T} is a number of transmit antennas (e.g., at BS), n is a time domain index in the unit of OFDM symbol, and m is a frequency domain index in the unit of sub-carrier or sub-band. That is, the 4D channel matrix H[n,m] can be expressed in a 4D domain that is represented by a receive antenna index of a receiver, a transmit antenna index of a transmitter, a time domain index, and a frequency domain index.

In an example, assuming n_{R}=1, then the MIMO channel can be expressed by a 3D matrix H_{3D}={h[i,n,m]:1≤i≤n_{T},1≤n≤N,1≤m≤M}, where N is a total number of OFDM symbols and M is a total number of sub-carriers or sub-bands. That is, the 3D matrix H_{3D} can be expressed in a 3D domain that is represented by a transmit antenna index of a transmitter, a time domain index, and a frequency domain index.

In an embodiment, H_{3D} can be transformed to a 3D domain that is represented by a beam component index, a delay component index, and a Doppler component index. The transformation can be performed by applying a 3D discrete Fourier transform (3D-DFT) on the 3D channel matrix H_{3D}. For example, let H̅_{3D} be the transformed channel matrix in the 3D domain that is represented by a beam component index, a delay component index, and a Doppler component index. That is, H̅_{3D}=3D-DFT (H_{3D})={h̅[j,k,l]:1≤j≤n_{T},1≤k≤N,1≤l≤M}, where j is a beam index, k is an index of Doppler components, and I is an index of delay components. In an example, if the beam component index and the delay component index are only considered, a 2D channel matrix can be obtained as H_{2D}={h[i,m]:1≤i≤n_{T},1≤m≤M}, and a transformed matrix of the 2D channel matrix H_{2D} can be expressed as H̅_{2D}=2D-DFT (H_{2D})={h̅[j,l]:1≤j≤n_{T},1≤l≤M}, by considering only one OFDM symbol.

In an embodiment, by applying a singular value decomposition (SVD), H_{3D} can be decomposed as H_{3D}=UΣV^{H}, where V is the precoder of the channel matrix.

In an embodiment, a covariance matrix of the channel matrix can be obtained as C=HH^{H}.

According to aspects of the disclosure, the MIMO CSI can be used in various processes that include, but are not limited to, precoding for MIMO channels, beamforming, user scheduling, interference alignment, and transmit antenna selection, and the like. However, the CSI feedback between a transmitter and a receiver may be delayed, causing a CSI aging issue. That is, a stale CSI value may be derived from the CSI feedback. In such a case, a prediction of future CSI values is needed.

In related arts, a convolutional neural network (CNN) or a recurrent neural network (RNN) can be used in the CSI prediction. However, the CNN based CSI prediction shows a poor performance with a higher complexity, and the RNN based CSI prediction shows a higher latency due to inherent sequential property of RNN. This disclosure provides a transformer based CSI prediction. Compared to the CNN or RNN based CSI prediction, the transformer based CSI prediction can provide a better performance in terms of mean square errors with a lower complexity.

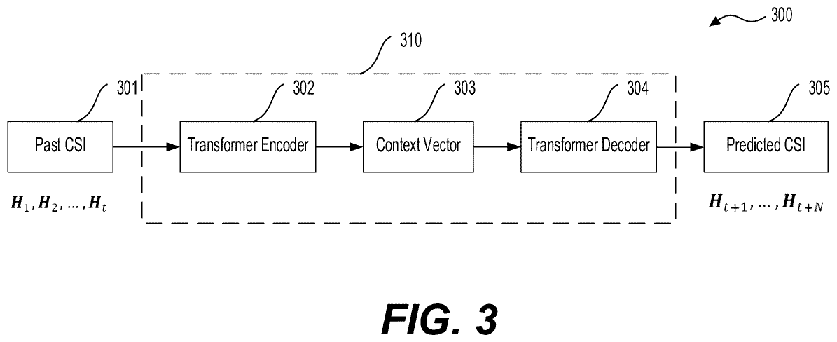

FIG. 3 shows an exemplary transformer based CSI prediction architecture 300 according to embodiments of the disclosure. In the transformer based CSI prediction architecture 300, a plurality of past CSI measurements (or CSI matrices) 301 can be parallel input to an encoder 302 of a transformer based neural network 310. Each past CSI measurement is measured at a different time instant. Based on the plurality of past CSI measurements 301, the encoder 302 can output a context vector (or a latent vector) 303. The context vector 303 is further input to a decoder 304 of the transformer based neural network 310. Based on the context vector 303, the decoder 304 can output one or more future (or predicted) CSI values (or CSI matrices) 305, for example, in a sequential order.

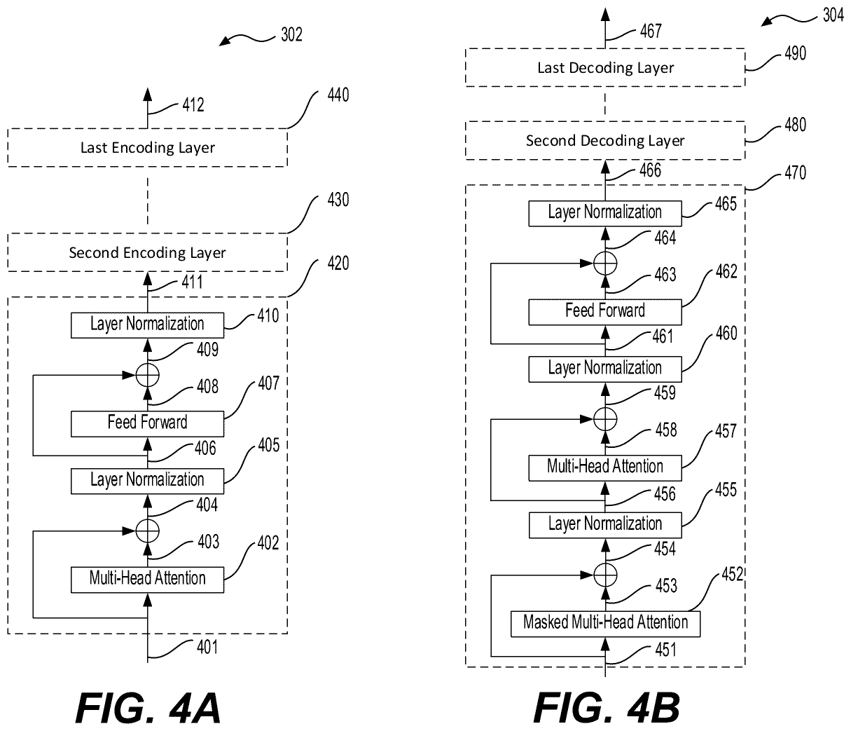

FIG. 4A shows an example of the encoder 302 of the transformer based CSI prediction architecture 300 according to embodiments of the disclosure. The encoder 302 can include a plurality of identical encoding layers 420, 430, and 440. Each encoding layer can include a multi-head attention sub-layer and a feed forward sub-layer. Taking a first encoding layer 420 as an example, a multi-head attention sub-layer 402 receives a first input 401 (e.g., the plurality of past CSI measurements 301) and generates a first output 403 based on the first input 401. A first residual connection is around the multi-head attention sub-layer 402. That is, the first input 401 is bypassed the multi-head attention sub-layer 402 to be added with the first output 403. A first sum 404, which is a sum of the first input 401 and the first output 403, is input to a first layer normalization 405. The first sum 404 is normalized as a first normalized sum 406 through the first layer normalization 405. The first normalized sum 406 is further input as a second input 406 to a feed forward sub-layer 407. The feed forward sub-layer 407 generates a second output 408 based on the second input 406. A second residual connection is around the feed forward sub-layer 407. That is, the second input 406 is bypassed the feed forward sub-layer 407 to be added with the second output 408. A second sum 409, which is a sum of the second input 406 and the second output 408, is input to a second layer normalization 410. The second sum 409 is normalized as a second normalized sum 411 through the second layer normalization 410. The second normalized sum 411 can be input to a next encoding layer 430. Through the plurality of encoding layers 420, 430, and 440, an extracted vector 412 (e.g., the context vector 303) can be output from the last encoding layer 440.

FIG. 4B shows an example of the decoder 304 of the transformer based CSI prediction architecture 300 according to embodiments of the disclosure. The decoder 304 can include a plurality of identical decoding layers 470, 480, and 490. Each decoding layer can include a masked multi-head attention sub-layer, a multi-head attention sub-layer, and a feed forward sub-layer. Taking a first decoding layer 470 as an example, a masked multi-head attention sub-layer 452 receives a first input 451 (e.g., the context vector 303) and generates a first output 453 based on the first input 451. A first residual connection is around the masked multi-head attention sub-layer 452. That is, the first input 451 is bypassed the masked multi-head attention sub-layer 452 to be added with the first output 453. A first sum 454, which is a sum of the first input 451 and the first output 453, is input to a first layer normalization 455. The first sum 454 is normalized as a first normalized sum 456 through the first layer normalization 455. The first normalized sum 456 is further input as a second input 456 to a multi-head attention sub-layer 457. The multi-head attention sub-layer 457 generates a second output 458 based on the second input 456. A second residual connection is around the multi-head attention sub-layer 457. That is, the second input 456 is bypassed the multi-head attention sub-layer 457 to be added with the second output 458. A second sum 459, which is a sum of the second input 456 and the second output 458, is input to a second layer normalization 460. The second sum 459 is normalized as a second normalized sum 461 through the second layer normalization 460. The second normalized sum 461 is further input as a third input 461 to a feed forward sub-layer 462. The feed forward sub-layer 462 generates a third output 463 based on the third input 461. A third residual connection is around the feed forward sub-layer 462. That is, the third input 461 is bypassed the feed forward sub-layer 462 to be added with the third output 463. A third sum 464, which is a sum of the third input 461 and the third output 463, is input to a third layer normalization 465. The third sum 464 is normalized as a third normalized sum 466 through the third layer normalization 465. The third normalized sum 466 can be input to a next decoding layer 480. Through the plurality of decoding layers 470, 480, and 490, the one or more predicted CSI values 305 can be generated from the last decoding layer 490, for example, in a sequential order.

It is noted that a number of the encoding layers in the encoder or a number of the decoding layers in the decoder is not limited, and can be one or more than one. In addition, each CSI measurement (or CSI matrix) can be a channel matrix or any variation of the channel matrix, such as a precoder matrix of the channel matrix, a covariance matrix of the channel matrix, a transformed matrix of the channel matrix, and the like.

In an embodiment, a multi-head attention sub-layer (e.g., 402 or 457) can have three input ports: query, key, and value. Each row (or column) vector of the CSI matrix can be input into the query and key ports, and correlation values of the row (or column) vectors of the CSI matrix can be input into the value port.

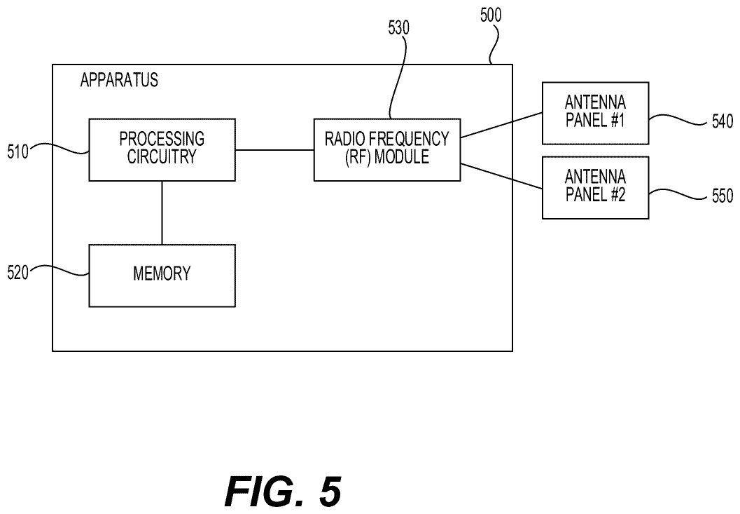

FIG. 5 shows an exemplary apparatus 500 according to embodiments of the disclosure. The apparatus 500 can be configured to perform various functions in accordance with one or more embodiments or examples described herein. Thus, the apparatus 500 can provide means for implementation of techniques, processes, functions, components, systems described herein. For example, the apparatus 500 can be used to implement functions of a UE or a base station (BS) (e.g., gNB) in various embodiments and examples described herein. The apparatus 500 can include a general purpose processor or specially designed circuits to implement various functions, components, or processes described herein in various embodiments. The apparatus 500 can include processing circuitry 510, a memory 520, and a radio frequency (RF) module 530.

In various examples, the processing circuitry 510 can include circuitry configured to perform the functions and processes described herein in combination with software or without software. In various examples, the processing circuitry 510 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 510 can be a central processing unit (CPU) configured to execute program instructions to perform various functions and processes described herein. Accordingly, the memory 520 can be configured to store program instructions. The processing circuitry 510, when executing the program instructions, can perform the functions and processes. The memory 520 can further store other programs or data, such as operating systems, application programs, and the like. The memory 520 can include a read only memory (ROM), a random access memory (RAM), a flash memory, a solid state memory, a hard disk drive, an optical disk drive, and the like.

The RF module 530 receives a processed data signal from the processing circuitry 510 and converts the data signal to beamforming wireless signals that are then transmitted via antenna panels 540 and/or 550, or vice versa. The RF module 530 can include a digital to analog convertor (DAC), an analog to digital converter (ADC), a frequency up convertor, a frequency down converter, filters and amplifiers for reception and transmission operations. The RF module 530 can include multi-antenna circuitry for beamforming operations. For example, the multi-antenna circuitry can include an uplink spatial filter circuit, and a downlink spatial filter circuit for shifting analog signal phases or scaling analog signal amplitudes. Each of the antenna panels 540 and 550 can include one or more antenna arrays.

In an embodiment, part of all the antenna panels 540/550 and part or all functions of the RF module 530 are implemented as one or more TRPs (transmission and reception points), and the remaining functions of the apparatus 500 are implemented as a BS. Accordingly, the TRPs can be co-located with such a BS, or can be deployed away from the BS.

The apparatus 500 can optionally include other components, such as input and output devices, additional or signal processing circuitry, and the like. Accordingly, the apparatus 500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

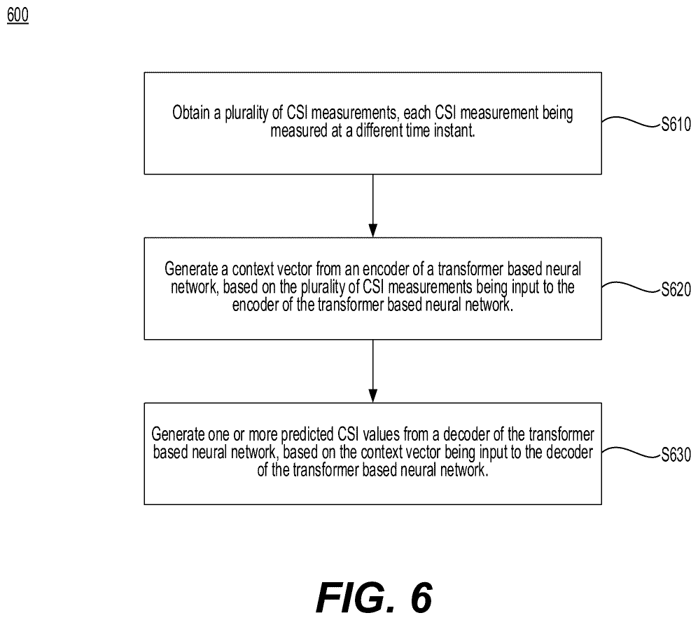

FIG. 6 shows a flowchart outlining a process 600 according to embodiments of the disclosure. The process 600 can be executed by the processing circuitry 510 of the apparatus 500. The process 600 may start at step S610.

At step S610, the process 600 obtains a plurality of CSI measurements. Each CSI measurement is measured at a different time instant. Then, the process 600 proceeds to step S620.

At step S620, the process 600 generates a context vector from an encoder of a transformer based neural network, based on the plurality of CSI measurements being input to the encoder of the transformer based neural network. Then, the process 600 proceeds to step S630.

At step S630, the process 600 generates one or more predicted CSI values from a decoder of the transformer based neural network, based on the context vector being input to the decoder of the transformer based neural network. Then, the process 600 terminates.

In an embodiment, the encoder includes one or more encoding layers each including a multi-head attention sub-layer and a feed-forward sub-layer.

In an embodiment, for each of the one or more encoding layers, a first residual connection is around the multi-head attention sub-layer followed by a first layer normalization, and a second residual connection is around the feed-forward sub-layer followed by a second layer normalization.

In an embodiment, the decoder includes one or more decoding layers each including a masked multi-head attention sub-layer, a multi-head attention sub-layer, and a feed-forward sub-layer.

In an embodiment, for each of the one or more decoding layers, a first residual connection is around the masked multi-head attention sub-layer followed by a first layer normalization, a second residual connection is around the multi-head attention sub-layer followed by a second layer normalization, and a third residual connection is around the feed-forward sub-layer followed by a third layer normalization.

In an embodiment, each CSI measurement is one of a channel matrix, a precoder matrix of the channel matrix, a covariance matrix of the channel matrix, and a transformed matrix of the channel matrix.

In an embodiment, the channel matrix is in a three dimensional domain that is represented by a transmit antenna index, a time domain index, and a frequency domain index.

In an embodiment, the transformed matrix is in a three dimensional domain that is represented by a transmit beam index, a delay component index, and a Doppler component index.

In an embodiment, the channel matrix is in a four dimensional domain that is represented by a receive antenna index, a transmit antenna index, a time domain index, and a frequency domain index.

In an embodiment, the transformed channel matrix is in a four dimensional domain that is represented by a receive beam index, a transmit beam index, a delay component index, and a Doppler component index.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for channel state information (CSI) prediction, the method comprising:
obtaining a plurality of CSI measurements, each CSI measurement being measured at a different time instant;
generating a context vector from an encoder of a transformer based neural network, based on the plurality of CSI measurements being input to the encoder of the transformer based neural network; and
generating one or more predicted CSI values from a decoder of the transformer based neural network, based on the context vector being input to the decoder of the transformer based neural network.

2. The method of claim 1, wherein the encoder includes one or more encoding layers each including a multi-head attention sub-layer and a feed-forward sub-layer.

3. The method of claim 2, wherein for each of the one or more encoding layers, a first residual connection is around the multi-head attention sub-layer followed by a first layer normalization, and a second residual connection is around the feed-forward sub-layer followed by a second layer normalization.

4. The method of claim 1, wherein the decoder includes one or more decoding layers each including a masked multi-head attention sub-layer, a multi-head attention sub-layer, and a feed-forward sub-layer.

5. The method of claim 4, wherein for each of the one or more decoding layers, a first residual connection is around the masked multi-head attention sub-layer followed by a first layer normalization, a second residual connection is around the multi-head attention sub-layer followed by a second layer normalization, and a third residual connection is around the feed-forward sub-layer followed by a third layer normalization.

6. The method of claim 1, wherein each CSI measurement is one of a channel matrix, a precoder matrix of the channel matrix, a covariance matrix of the channel matrix, and a transformed matrix of the channel matrix.

7. The method of claim 6, wherein the channel matrix is in a three dimensional domain that is represented by a transmit antenna index, a time domain index, and a frequency domain index.

8. The method of claim 6, wherein the transformed matrix is in a three dimensional domain that is represented by a transmit beam index, a delay component index, and a Doppler component index.

9. The method of claim 6, wherein the channel matrix is in a four dimensional domain that is represented by a receive antenna index, a transmit antenna index, a time domain index, and a frequency domain index.

10. The method of claim 6, wherein the transformed channel matrix is in a four dimensional domain that is represented by a receive beam index, a transmit beam index, a delay component index, and a Doppler component index.

11. An apparatus, comprising:
processing circuitry configured to
obtain a plurality of CSI measurements, each CSI measurement being measured at a different time instant;
generate a context vector from an encoder of a transformer based neural network, based on the plurality of CSI measurements being input to the encoder of the transformer based neural network; and
generate one or more predicted CSI values from a decoder of the transformer based neural network, based on the context vector being input to the decoder of the transformer based neural network.

12. The apparatus of claim 11, wherein the encoder includes one or more encoding layers each including a multi-head attention sub-layer and a feed-forward sub-layer.

13. The apparatus of claim 12, wherein for each of the one or more encoding layers, a first residual connection is around the multi-head attention sub-layer followed by a first layer normalization, and a second residual connection is around the feed-forward sub-layer followed by a second layer normalization.

14. The apparatus of claim 11, wherein the decoder includes one or more decoding layers each including a masked multi-head attention sub-layer, a multi-head attention sub-layer, and a feed-forward sub-layer.

15. The apparatus of claim 14, wherein for each of the one or more decoding layers, a first residual connection is around the masked multi-head attention sub-layer followed by a first layer normalization, a second residual connection is around the multi-head attention sub-layer followed by a second layer normalization, and a third residual connection is around the feed-forward sub-layer followed by a third layer normalization.

16. The apparatus of claim 11, wherein each CSI measurement is one of a channel matrix, a precoder matrix of the channel matrix, a covariance matrix of the channel matrix, and a transformed matrix of the channel matrix.

17. The apparatus of claim 16, wherein the channel matrix is in a three dimensional domain that is represented by a transmit antenna index, a time domain index, and a frequency domain index.

18. The apparatus of claim 16, wherein the transformed matrix is in a three dimensional domain that is represented by a transmit beam index, a delay component index, and a Doppler component index.

19. The apparatus of claim 16, wherein the channel matrix is in a four dimensional domain that is represented by a receive antenna index, a transmit antenna index, a time domain index, and a frequency domain index.

20. The apparatus of claim 16, wherein the transformed channel matrix is in a four dimensional domain that is represented by a receive beam index, a transmit beam index, a delay component index, and a Doppler component index.
